(19) United States
(12) Patent Application Publication
(10) Pub. No.: US 2015/0020984 A1
(43) Pub. Date: Jan. 22, 2015

(54) ADJUSTABLE WINDOW BLIND SUPPORT SYSTEM AND METHOD THEREFOR

(71) Applicant: JIM FENNELL, LAS VEGAS, NV (US)

(72) Inventor: JIM FENNELL, LAS VEGAS, NV (US)

(21) Appl. No.: 14/333,345

(22) Filed: Jul. 16, 2014

Related U.S. Application Data
(60) Provisional application No. 61/847,414, filed on Jul. 17, 2013.

(51) Int. Cl. E06B 9/44

(52) U.S. Cl. CPC E06B 9/44
USPC 160/323.1

(57) ABSTRACT

A system for securing a head rail of a window blind to a window frame has a first end cap configured to be inserted into the head rail. A threaded channel is formed through the first end cap. A second end cap is configured to be inserted into the head rail. Securing devices are formed on a rear surface of the second end cap. An adjustable head member is rotatably attached to the first end cap. A retaining pin extends from the adjustable head member.

### RELATED APPLICATIONS

This patent application is related to U.S. Provisional Application No. 61/847,414, filed Jul. 17, 2013, entitled “AN ADJUSTABLE WINDOW BLIND INSTALLATION SYSTEM AND METHOD THEREFOR” in the name of the same inventors stated above, and which is incorporated herein by reference in its entirety. The present patent application claims the benefit under 35 U.S.C §119(e)

### TECHNICAL FIELD

The present invention relates to a window blind support, and more particularly to an adjustable window blind support system that uses a single adjustable end cap to allow a user to easy and quickly install a window bind.

### BACKGROUND

Many people like to install window blinds or other window treatments in homes and or offices for several different reasons. For example, window blinds may be used as a way to keep sun light and/or noise outside a room. Window blinds may further be used to ensure privacy in the room by preventing others on the outside from looking into a room from the window. Window blinds may also be used for as a way to decorate a room.

Presently, in order to install window blinds, a user generally needs to install left and right sided mounting brackets to the wall or at the top of a window frame area. This generally requires the user place markings on the wall or at the top of a window frame area to ensure that the left and right sided mounting brackets are properly aligned. Once the markings are made, the user generally uses a power tool to secure the left and right sided mounting brackets to the wall or at the top of a window frame area with one or more screws, bolts or similar like items.

Some window blinds may use adjustable length tension rods as an alternative to the rod and permanent affixed mounting brackets that are currently used. Adjustable length tension rods provide for simpler installation and prevent permanent damage to the support surfaces upon removal. However, adjustable length tension rods also have several issues. For example, in some poorly made adjustable tension rods, the spring mechanism in the adjustable length tension rod tends to lose elasticity over time. Thus, the adjustable length tension rod may not be able to firmly secure the window blinds to the window frame causing the window blinds to fall. Also, if the spring mechanism in the adjustable length tension rod is too stiff, some users may not be able to push the ends of the adjustable length tension rod together to install the adjustable length tension rod in the window frame.

Therefore, it would be desirable to provide a system and method that overcomes the above.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter

In accordance with one embodiment, a system for securing a head rail of a window blind to a window frame has a first end cap configured to be inserted into the head rail. A threaded channel is formed through the first end cap. A second end cap is configured to be inserted into the head rail. Securing devices are formed on a rear surface of the second end cap. An adjustable head member is rotatably attached to the first end cap. A retaining pin extends from the adjustable head member.

In accordance with another embodiment, a system for securing a head rail of a window blind to a window frame has a first end cap configured to be inserted into the head rail. A threaded channel is formed through the first end cap. A second end cap is configured to be inserted into the head rail. Securing devices formed on a rear surface of the second end cap. An adjustable head member is rotatably attached to the first end cap. The adjustable head member has a face plate. A retaining pin extends from a center area on a front surface of the face plate. A threaded rod extends from a center area on a rear surface of the face plate. A center support clip is provided for holding and supporting the head rail.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a perspective view of one end of a window blind head rail using an adjustable head cap of the adjustable window blind installation system of the present invention;

FIG. 2A is a perspective rear view of an adjustment device used in the adjustable window blind installation system of FIG. 1;

FIG. 2B is a rear view of the adjustment device of FIG. 2A;

FIG. 2C is a perspective front view of the adjustment device of FIG. 2A;

FIG. 2D is a front view of the adjustment device of FIG. 2A;

FIG. 3A is a rear view of a wall plate used in the adjustable window blind installation system of FIG. 1;

FIG. 3B is a side view of the wall plate of FIG. 4A;

FIG. 3C is a front view of the wall plate of FIG. 4A;

FIG. 4A is a side view of a center holding clip used in the adjustable window blind installation system of FIG. 1;

FIG. 4B is a front view center holding clip of FIG. 4A;

FIG. 4C is a top view of the center holding clip of FIG. 4A;

FIG. 4D is a rear view of the center holding clip of FIG. 4A;

FIG. 5A is a front perspective of an end cap used in the adjustable window blind installation system of FIG. 1;

FIG. 5B is a rear perspective of an end cap used in the adjustable window blind installation system of FIG. 1;

FIG. 6 is a side view of another embodiment of the adjustable head cap;

FIG. 7 is a front prospective view of another embodiment of the first end cap with the adjustment device;

FIG. 8 is a rear prospective view of the of the first end cap depicted in FIG. 7 with the adjustment device;

FIG. 9 is a front prospective view of another embodiment of an end cap used with the first end cap depicted in FIG. 7; and

FIG. 10 is a rear prospective view of the end cap depicted in FIG. 9 used with the first end cap depicted in FIG. 7.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

Referring to the Figures, an adjustable window blind installation system 10 (herein system 10) will be disclosed. The system 10 may be used in conjunction with a head rail 12 Of a window blind. The system 10 is adjustable such that a single adjustable end cap may be used to allow a user to easy and quickly install the window bind.

The system 10 may have a first end cap 14. The first end cap 14 may be configured to fit over one end of the head rail 12. The first end cap 14 is further designed to fit securely within an inner channel 12A of the head rail 12. The design of the first end cap 14 allows one to securely fit the first end cap 14 to one end of the head rail 12 without the use of any tools.

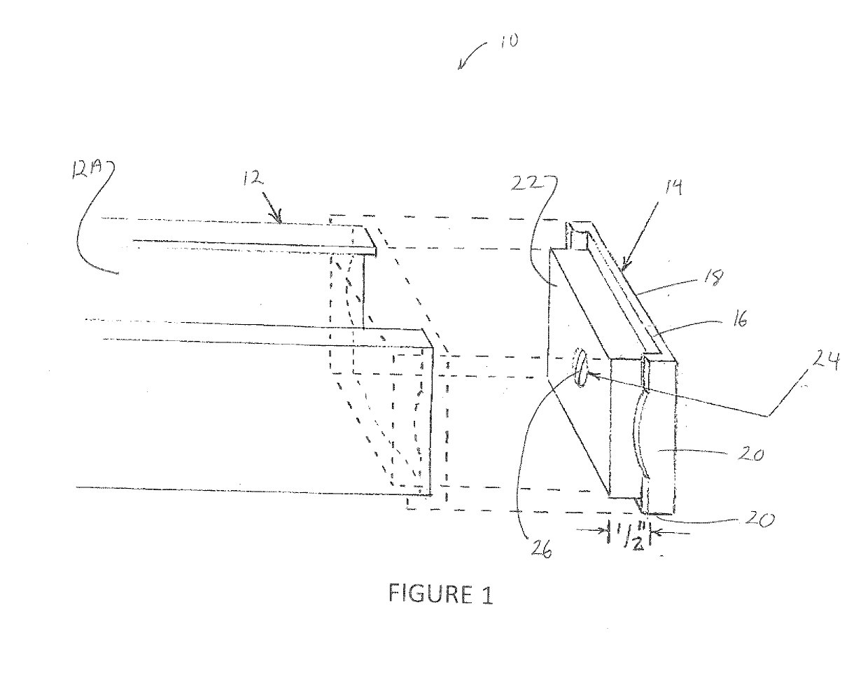

In the embodiment shown in FIG. 1, the first end cap 14 has a body section 16. The body section 16 may have a planer member 18. A plurality of side walls 20 may extend up from a plurality of side edges of the planer member 18. In the present embodiment, three side walls 20 are shown. However, this is shown as an example and should not be seen in a limiting manner. The planer member 18 and side walls 20 are dimensioned to fit around an outer diameter of one end of the head rail 12. The planer member 18 and the side walls 20 may be formed out of the same material. In general, a lightweight but sturdy material may be used. For example, the planer member 18 and the side walls 20 may be formed of hardened plastic, aluminum, or the like.

Attached to an interior surface of the planer member 18 may be plug member 22. The plug member 22 is configures to fit within the inner channel 12A of the head rail 12 thereby securing the first end cap 14 to one end of the head rail 12 without the use of any tools. The plug member 22 may be formed of the same material as the planer member 18 and the side walls 20. Alternatively, the plug member 22 may be formed of a slide resistant material such as rubber or the like.

A channel 24 may be formed through a central section of the plug member 22. The channel 24 may have threads 26. The threads 26 may be used to rotatably secure a device in the channel 24.

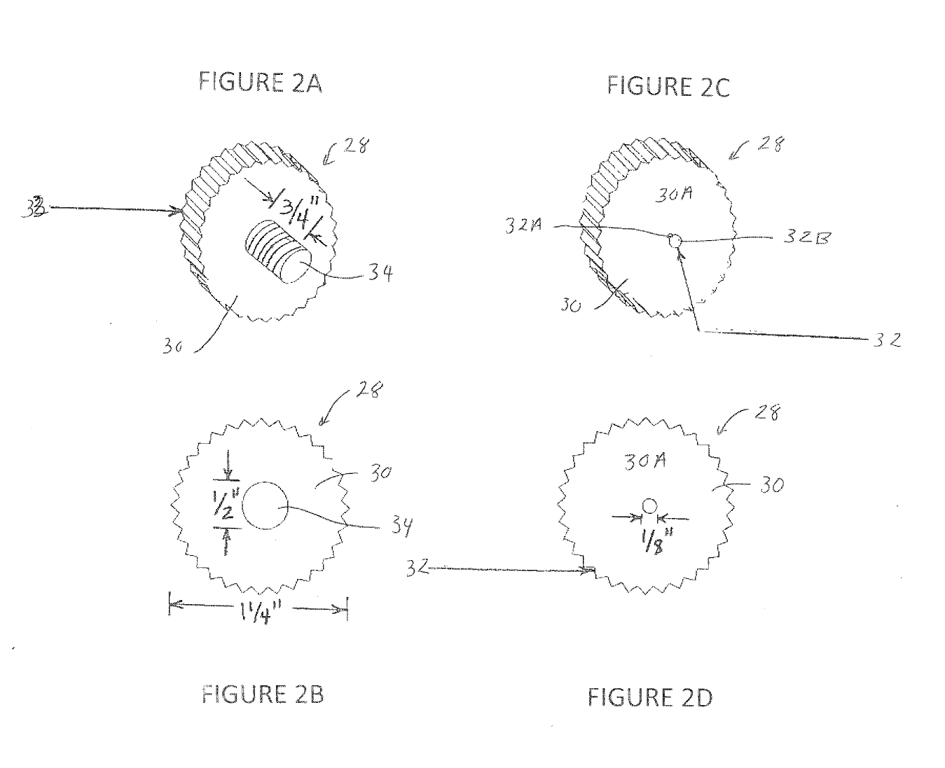

Referring to FIGS. 2A-2D, an adjustable head member 28 is shown. The adjustable head member 28 has a face plate 30. The face plate 30 may come in various shapes and or sizes. In the present embodiment, the face plate 30 is circular in shape and has a plurality of ridges 31 formed around an outer perimeter thereof. The circular shape of the face plate 30 as well as the ridges 31 formed along the outer perimeter of the face plate 30 allows a user to easily rotate the adjustable head member 28 when being used in the system 10 as will be explained below.

A retaining pin 32 may extend up from a center area on a front surface 30A the face plate 30. In accordance with one embodiment, the retaining pin 32 may be formed of a rod member 32A with a ball member 32B on a distal end thereof. The above is given as one example of the retaining pin 32 and should not be seen in a limiting manner. Other embodiments of the retaining pin 32 may be used without departing from the spirit and scope of the present invention.

A threaded rod 34 may extend up from a center area on a rear surface 30B the face plate 30. The threaded rod 34 may be used to engage the channel 24 having threads 26 formed in the plug member 22. Thus, by rotating the adjustable head member 28, one can adjust a length of the head rail 12 to which the system 10 is being used to install.

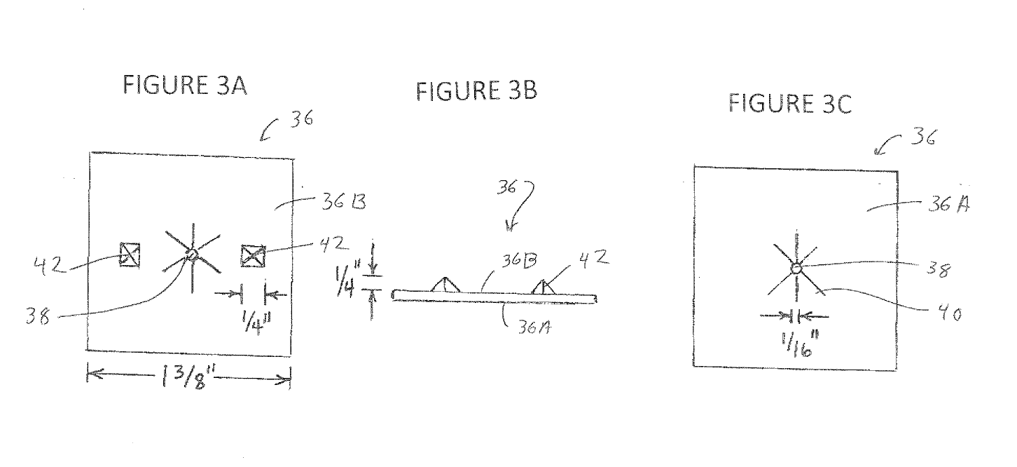

Referring now to FIGS. 3A-3C, a holding clip 36 is shown. The holding clip 36 may be used to receive and hold the retaining pin 32 of the adjustable head member 28. The holding clip 36 may have a front surface 36A having an opening 38 formed through the holding clip 36. The opening 38 may be configured to receive and hold the retaining pin 32. In accordance with one embodiment, a plurality of slits and or perforations 40 (hereinafter slits 40) may be formed through the holding clip 36 and extending away from the opening 38. The slits 40 may be used to aid in allow the retaining pin 32 to be inserted into the opening 38.

Located on a rear surface 36B of the holding clip 36 are one or more fastening members 42. The fastening members 42 may be sued to secure the holding clip 36 to a window frame where the head rail 12 is to be installed. While FIG. 3A shows two fastening members 42, this is only shown as an example and should not be seen in a limiting manner. The fastening members may be spike like members which may be pressed into the surface of the window frame to secure the holding clip 36 to the window frame.

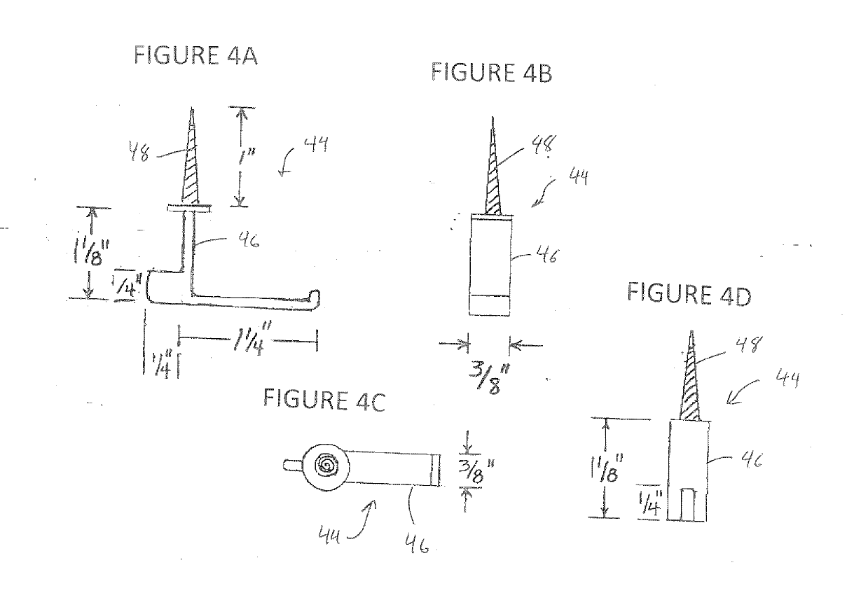

Referring now to FIGS. 4A-4D, the system 10 may have a center support clip 44. The center support clip 44 may be used to further support the head rail 12. The center support clip 44 may have an “L” shaped body member 46. A bottom leg of the “L” shaped body member 46 may be used to support and hold the head rail 12. An attachment device 48 may extend up from a top of the L” shaped body member 46. The attachment device 48 may be used to secure the “L” shaped body member 46 to the window frame where the head rail 12 is being installed. In accordance with one embodiment, the attachment device 48 may be a threaded screw or the like. The above is given as an example and should not be seen in a limiting manner.

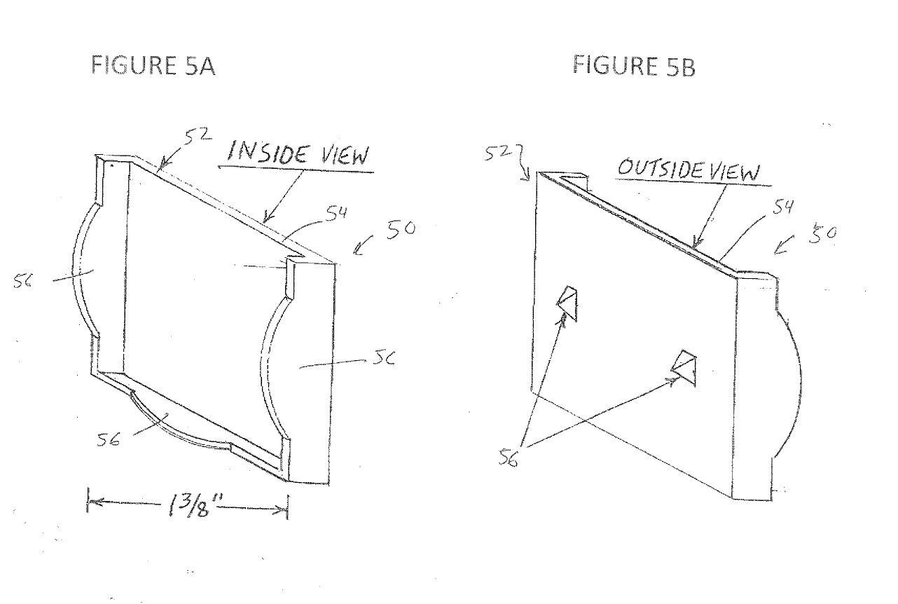

Referring to FIG. 5A-5B, a second end cap 50 for the system 10 is shown. The second end cap 50 is similar to the first end cap 12. The second end cap 50 may have a body section 52. The body section 52 may have a planer member 54. A plurality of side walls 56 may extend up from a plurality of side edges of the planer member 54. In the present embodiment, three side walls 56 are shown. However, this is shown as an example and should not be seen in a limiting manner. The planer member 54 and side walls 56 are dimensioned to fit around an outer diameter of one end of the head rail 12. The planer member 54 and the side walls 56 may be formed out of the same material. In general, a lightweight but sturdy material may be used such as hardened plastic, aluminum, or the like.

A rear surface of the planer member 54 may have fastening members 56. The fastening members 56 may be used to secure the second end cap 50 to the window frame where the head rail 12 is to be installed. While FIG. 5B shows two fastening members 56, this is only shown as an example and should not be seen in a limiting manner. The fastening members 56 may be spike like members which may be pressed into the surface of the window frame.

Referring now to all the Figures, the operation of the system 10 will be disclosed. In general, the first end cap 12 and the second end cap 50 may be attached to each end of the head rail 12 of the window blind. The adjustable head member 28 is then rotatably connected to the plug member 22 of the first end cap 12.

The holding clip 36 may be secured to the window frame where the head rail 12 is to be installed. The holding clip 36 may be secured to the wall frame by pressing the fastening members 42 firmly into the window frame.

Next, the second end cap 50 may be secured to the wall frame. The second end cap 50 should be aligned with the holding clip 36 when being installed. The second end cap 50 may be secured by pressing the fastening members 56 into the window frame.

Next, the adjustable head member 28 is rotated such that the retaining pin 32 can be positioned within the opening 38 of the holding clip 36.

To provide additional support, the center support clip 44 may be secured to the window frame. The center support clip 44 may be used to further support the head rail 12.

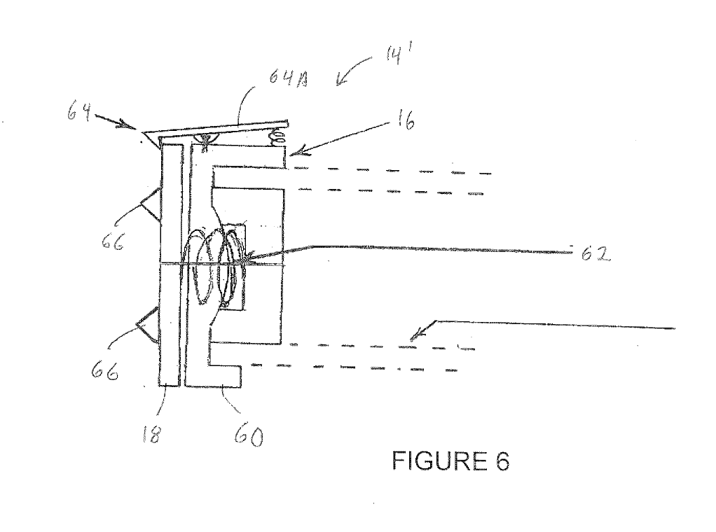

Referring now to FIGS. 1 and 6, another embodiment of the first end cap 14′ is shown. The first end cap 14′ may be configured to fit over one end of the head rail 12. The first end cap 14′ is further designed to fit securely within an inner channel 12A of the head rail 12. The design of the first end cap 14 allows one to securely fit the first end cap 14 to one end of the head rail 12 without the use of any tools.

In the embodiment shown in FIG. 1, the first end cap 14 has a body section 16. The body section 16 may have a planer member 18. A “U” shaped member 60 may be coupled to the planer member 18. In accordance with one embodiment, the “U” shaped member 60 may be adjustably coupled to the planer member 18. A spring member 62 may be used to adjustably couple the “U” shaped member 30 to the planer member 18. In operation, the “U” shaped member 30 may be configured to fit over the end of the head rail 12 (FIG. 1).

A locking device 64 may be coupled to the “U” shaped member 30 and the planer member 18. The locking device 64 may be used to secure the position of the “U” shaped member 60 to the planer member 18. In accordance with one embodiment, the locking device may be a spring activated lever 64A.

A rear surface of the planer member 18 may have fastening members 66. The fastening members 66 may be used to secure the first end cap 14′ to the window frame where the head rail 12 is to be installed. While FIG. 6 shows two fastening members 66, this is only shown as an example and should not be seen in a limiting manner. The fastening members 66 may be spike like members which may be pressed into the surface of the window frame.

Referring now to FIGS. 1-6, in operation, the first end cap 14′ and the second end cap 50 may be attached to each end of the head rail 12 of the window blind.

Next, the first end cap 14′ and second end cap 50 may be secured to the wall frame. The first end cap 14′ and the second end cap 50 may be secured by pressing the fastening members 66 and 56 respectively into the window frame.

Next, the locking device 64 may be used to couple the “U” shaped member 30 which may be adjustably coupled to the planer member 18. In general, the head rail may push the spring member inward. The locking device 64 may be used to secure the position of the “U” shaped member 30 relative to the planer member 18.

To provide additional support, the center support clip 44 may be secured to the window frame. The center support clip 44 may be used to further support the head rail 12.

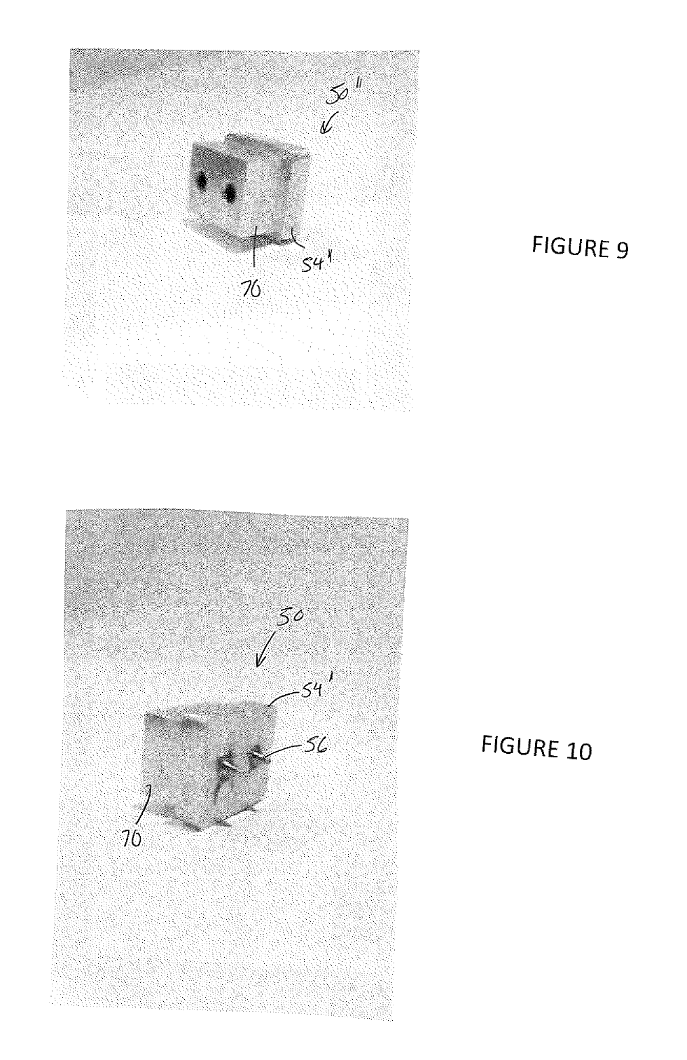

Referring now to FIGS. 8 and 9, another embodiment of the first end cap 14″ is shown. The first end cap 14″ may be configured to fit over one end of the head rail 12 (FIG. 1). The first end cap 14″ is further designed to fit securely within an inner channel 12A (FIG. 1) of the head rail 12. The design of the first end cap 14″ allows one to securely fit the first end cap 14″ to one end of the head rail 12 without the use of any tools.

In the embodiment shown in FIGS. 8 and 9, the first end cap 14″ has a body section 16″. The body section 16″ may have a planer member 18″. Extending out from the planer member 18″ may be plug member 22″. The plug member 22″ is configures to fit within the inner channel 12A of the head rail 12 thereby securing the first end cap 14″ to one end of the head rail 12 without the use of any tools. The plug member 22″ may be formed of the same material as the planer member 18″. Alternatively, the plug member 22″ may be formed of a slide resistant material such as rubber or the like. In the present embodiment, the planer member 18″ and the plug member 22″ may be formed of a single member.

A channel 24″ may be formed through a central section of the plug member 22″ and the planer member 18″. The channel 24″ may have threads 26″. The threads 26″ may be used to rotatably secure a device in the channel 24″.

In the embodiment shown in FIGS. 8-9, the adjustable head member 28″ has a face plate 30″. The face plate 30 may come in various shapes and or sizes. In the present embodiment, the face plate 30″ is circular in shape and has a plurality of ridges 31″ formed around an outer perimeter thereof. The circular shape of the face plate 30″ as well as the ridges 31″ formed along the outer perimeter of the face plate 30″ allows a user to easily rotate the adjustable head member 28″.

A retaining pin 32″ may extend up from a center area on a front surface 30A″ the face plate 30″. In accordance with the present embodiment, the retaining pin 32″ may be formed of a spike member 33″. The above is given as one example of the retaining pin 32″ and should not be seen in a limiting manner. Other embodiments of the retaining pin 32″ may be used without departing from the spirit and scope of the present invention.

A threaded rod 34″ may extend up from a center area on a rear surface 30B″ the face plate 30″. The threaded rod 34″ may be used to engage the channel 24″ having threads 26″ formed in the plug member 22″. Thus, by rotating the adjustable head member 28″, one can adjust a length of the head rail 12″ to which the system 10 is being used to install.

Referring to FIG. 9-10, another embodiment of the second end cap 50″ is shown. The second end cap 50″ is similar to the first end cap 12″. The second end cap 50″ may have a body section 52″. The body section 52″ may have a planer member 54″.

Extending out from the planer member 54″ may be plug member 70″. The plug member 70″ is configures to fit within the inner channel 12A of the head rail 12 thereby securing the second end cap 50″ to another end of the head rail 12 without the use of any tools. The plug member 70″ may be formed of the same material as the planer member 54″. Alternatively, the plug member 54″ may be formed of a slide resistant material such as rubber or the like. In the present embodiment, the planer member 54″ and the plug member 22″ may be formed as a single unit.

A rear surface of the planer member 54″ may have fastening members 56″. The fastening members 56″ may be used to secure the second end cap 50″ to the window frame where the head rail 12 is to be installed. While FIG. 10 shows two fastening members 56″, this is only shown as an example and should not be seen in a limiting manner. The fastening members 56″ may be spike like members which may be pressed into the surface of the window frame.

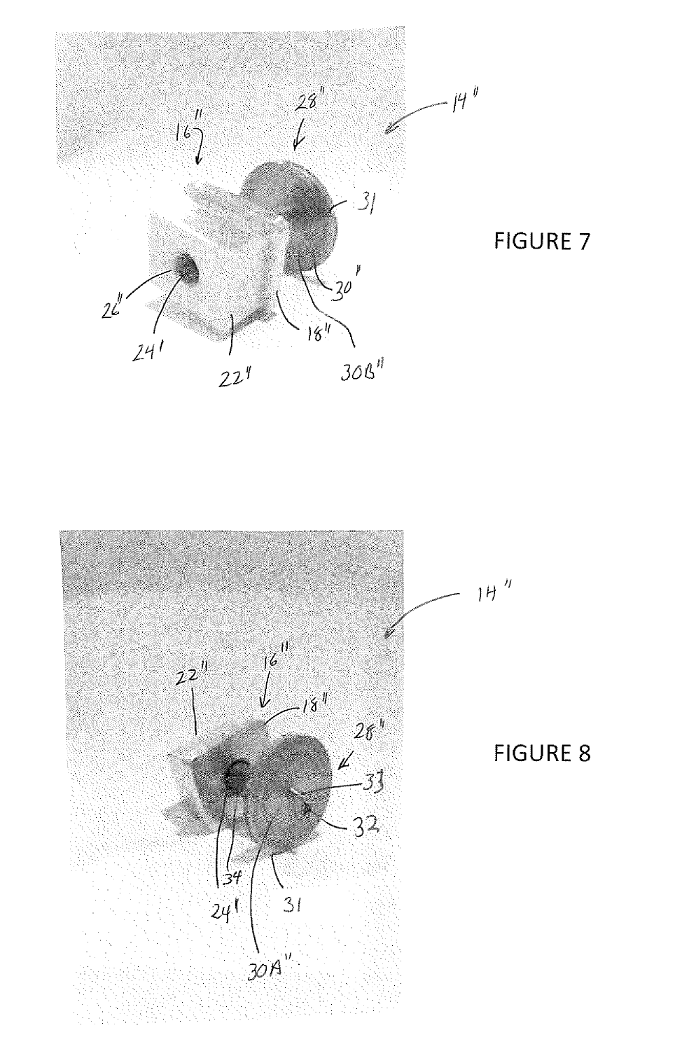

Referring to FIGS. 7-10, the operation of the system depicted in FIGS. 7-10 will be disclosed. In general, the first end cap 12″ and the second end cap 50″ may be attached to each end of the head rail 12 (FIG. 1) of the window blind. The adjustable head member 28 is then rotatably connected to the planer member 18″ of the first end cap 12″. The second end cap 50″ may then be secured to the wall frame. The second end cap 50″ may be secured by pressing the fastening members 56″ into the window frame. The head rail 12 is then aligned so that the head rail 12 is level along a horizontal plane. Once the head rail 12 is aligned, the adjustable head member 28″ is rotated such so that the retaining pin 32″ engages the window frame. The adjustable head member 28″ should be rotated such so that the retaining pin 32″ firmly engages the window frame.

To provide additional support, the center support clip 44 may be used. The center support clip 44 may be secured to the window frame. The center support clip 44 may be used to further support the head rail 12 by having the bottom leg of the “L” shaped body member 46 positioned underneath and holding and supporting the head rail 12.

While embodiments of the disclosure have been described in terms of various specific embodiments, those skilled in the art will recognize that the embodiments of the disclosure may be practiced with modifications within the spirit and scope of the claims.

What is claimed is:

1. A system for securing a head rail of a window blind to a window frame comprising:
a first end cap configured to be inserted into the head rail, wherein a threaded channel is formed through the first end cap;
a second end cap configured to be inserted into the head rail, securing devices formed on a rear surface of the second end cap; and
an adjustable head member rotatably attached to the first end cap, wherein a retaining pin extends from the adjustable head member.

2. The system of claim 1, further comprising a center support clip for holding and supporting the head rail.

3. The system of claim 1, wherein the first end cap comprises:
a first end cap body section;
a first end cap plug member extending from the first end cap body section, wherein the first end cap plug member is configured to fit within the head rail to secure the first end cap to one end of the head rail;
wherein the threaded channel is formed through a central section of the first end cap body section and the first end cap plug member.

4. The system of claim 1, wherein the second end cap comprises:
a second end cap body section; and
a second end cap plug member extending from the second end cap body section, the second end cap plug member is configured to fit within the head rail to secure the second end cap to another end of the head rail;
wherein the securing devices are formed on a rear surface of the second end cap body section to secure the second end cap to the window frame.

5. The system of claim 3, wherein the first end cap body section is substantially planer.

6. The system of claim 4, wherein the second end cap body section is substantially planer.

7. The system of claim 1, wherein the adjustable head member comprises:
a face plate, wherein the retaining pin extends from a center area on a front surface of the face plate; and
a threaded rod extending from a center area on a rear surface of the face plate.

8. The system of claim 7, wherein the face plate is circular in shape and has a plurality of ridges formed around an outer perimeter thereof.

9. The system of claim 2, wherein the center support clip comprises:
an “L” shaped body member, wherein a bottom leg of the “L” shaped body member supports and hold the head rail; and
an attachment device extending up from a top of the L” shaped body member to secure the “L” shaped body member to the window frame.

10. A system for securing a head rail of a window blind to a window frame comprising:
a first end cap configured to be inserted into the head rail, wherein a threaded channel is formed through the first end cap;
a second end cap configured to be inserted into the head rail, securing devices formed on a rear surface of the second end cap;
an adjustable head member rotatably attached to the first end cap, wherein a retaining pin extends from the adjustable head member wherein the adjustable head member comprises:
a face plate, wherein the retaining pin extending from a center area on a front surface of the face plate; and
a threaded rod extending from a center area on a rear surface of the face plate;
a center support clip for holding and supporting the head rail.

11. The system of claim 10, wherein the first end cap comprises:
a first end cap body section;
a first end cap plug member extending from the first end cap body section, wherein the first end cap plug member is configured to fit within the head rail to secure the first end cap to one end of the head rail;
wherein the threaded channel is formed through a central section of the first end cap body section and the first end cap plug member.

12. The system of claim 10, wherein the second end cap comprises:
a second end cap body section;
a second end cap plug member extending from the second end cap body section, the second end cap plug member is configured to fit within the head rail to secure the second end cap to another end of the head rail 12; and
at last one fastening member formed on a rear surface of the second end cap body section to secure the second end cap to the window frame.

13. The system of claim 11, wherein the first end cap body section is substantially planer.

14. The system of claim 12, wherein the second end cap body section is substantially planer.

15. The system of claim 10, wherein the face plate is circular in shape and has a plurality of ridges formed around an outer perimeter thereof.

16. The system of claim 10, wherein the center support clip comprises:
an “L” shaped body member, wherein a bottom leg of the “L” shaped body member supports and hold the head rail; and
an attachment device extending up from a top of the L” shaped body member to secure the “L” shaped body member to the window frame.

17. A system for securing a head rail of a window blind to a window frame comprising:
a first end cap configured to be inserted into the head rail, wherein the first end cap comprises:
a first end cap body section;
a first end cap plug member extending from the first end cap body section, wherein the first end cap plug member is configured to fit within the head rail to secure the first end cap to one end of the head rail;
a threaded channel formed through a central section of the first end cap body section and the first end cap plug member;
a second end cap configured to be inserted into the head rail, wherein the second end cap comprises:
a second end cap body section;
a second end cap plug member extending from the second end cap body section, the second end cap plug member configured to fit within the head rail to secure the second end cap to another end of the head rail; and
at last one fastening member formed on a rear surface of the second end cap body section to secure the second end cap to the window frame;
an adjustable head member rotatably attached to the first end cap, wherein a retaining pin extends from the adjustable head member;
a center support clip for holding and supporting the head rail.

18. The system of claim 17, wherein the adjustable head member comprises:
a face plate, wherein the retaining pin extends from a center area on a front surface of the face plate; and
a threaded rod extending from a center area on a rear surface of the face plate.

19. The system of claim 18, wherein the face plate is circular in shape and has a plurality of ridges formed around an outer perimeter thereof.

20. The system of claim 17, wherein the center support clip comprises:
an “L” shaped body member, wherein a bottom leg of the “L” shaped body member supports and hold the head rail; and
an attachment device extending up from a top of the L” shaped body member to secure the “L” shaped body member to the window frame.
